(19) United States
(12) Patent Application Publication
(10) Pub. No.: US 2022/0100803 A1
(43) Pub. Date: Mar. 31, 2022

(54) SYSTEM, METHOD AND APPLICATION FOR MATCHING PROFILES OF USERS

(71) Applicant: Lucinda Pineiro, Queen Creek, AZ (US)

(72) Inventor: Lucinda Pineiro, Queen Creek, AZ (US)

(21) Appl. No.: 17/484,359

(22) Filed: Sep. 24, 2021

Related U.S. Application Data
(60) Provisional application No. 63/083,139, filed on Sep. 25, 2020.

(51) Int. Cl. G06F 16/9035; H04L 29/08; G06Q 50/00; G06K 9/00; G06F 16/904; G06F 16/907

(52) U.S. Cl. CPC G06F 16/9035; H04L 67/306; G06Q 50/01; G06F 16/907; G06K 9/00248; G06F 16/904; G06K 9/00288

(57) ABSTRACT

The present invention relates to a system and method for matching users, especially fitness enthusiasts, for the purposes of friendship, a relationship, a pen pal, a gym partner, etc. The system is configured to register users on the system and authenticate uploaded photographs by using facial recognition algorithms and motion detection techniques to prevent fake profiles and bots. The system and method displays the profiles relevant to the user on a user interface of the computer-implemented application and enables the user to swipe up to dislike the displayed profiles and swipe down to like the profiles. The user is allowed to choose from a plurality of subscription levels that allow the user to chat, as well as discover and strengthen his or her profile. The system provides a filtering system to filter users via various criteria.

### CROSS-REFERENCE TO RELATED APPLICATION

The present application claims priority to, and the benefit of, U.S. Provisional Application No. 63/083,139, which was filed on Sep. 25, 2020 and is incorporated herein by reference in its entirety.

### FIELD OF THE INVENTION

The present invention relates generally to dating and friendship software applications. More specifically, the present invention relates to a system, method and a computer-implemented application that facilitates matching of user profiles, especially for fitness enthusiasts, for the purposes of a friendship, a relationship, a pen pal, a gym partner, etc. The system has a client-server architecture that uses a computer-implemented application installed in a user device communicating with a server. The user profiles are stored in one or more databases and are used for displaying matching user profiles for the user. Accordingly, this disclosure makes specific reference thereto the present invention. Nonetheless, it is to be appreciated that aspects of the present invention are also equally applicable to other like applications, devices and methods of manufacture.

### BACKGROUND

Human beings by nature are social. Thus, people like to socialize with each other and want to make new friends who have similar likes and interests. For socializing, increasing numbers of people have turned to online services to meet new people and make new friends. Online dating allows users to connect and get to know one another online via a computer prior to a face-to-face meeting. Further, online dating has become an acceptable method for finding a mate. Typically, online dating sites require a user to generate a profile page, wherein characteristics of the user are displayed. Desired characteristics of a potential and desired partner can also be provided by the user and displayed. However, in current methods and systems, such information provided by the user can be false or not entirely truthful, potentially misleading other users. Also, these conventional dating apps can be ineffective and filled with people using fake profiles.

In conventional online dating services or mobile dating apps, a user routinely faces the task of critiquing a large number of profiles that meet the user's general descriptions for potential dates, friendship, etc. For this purpose, apps allow users to make quick “like” or “dislike” decisions on recommended users based on a single profile photo of another user. For example, the Tinder™ smartphone application allows the user to accept or reject another user with a single left or right swipe on the other user's profile photo. Further, for fitness enthusiasts, there is no product or service available that allows them to meet other fitness enthusiasts.

Further, in many cases, a person is not aware of the likes and dislikes of the other person. For example, people may lack ways to meet others who are fitness enthusiasts for gym sessions. There is no dating app that enables users to seek out other users based on filtered parameters such as body type, height, age, gym location, etc. Therefore, being able to meet and meet up with like-minded people, such as fitness enthusiasts, is difficult in such scenarios.

Thus, the present invention has been made in view of the above circumstances, as there is not an effective dating app that enables user to meet up with like-minded people. Typically, the standard dating apps in the market may be ineffective and filled with people using fake profiles.

Therefore, there exist a long felt need in the art for a system and method that allows users, especially fitness enthusiasts, to create a profile and match with others for dating and friendship purposes. There is also a long felt need in the art for a system and method that ensures the user is not fake and creates a true and relevant profile. Additionally, there is a long felt need in the art for a dating app that enables users to seek out other users based on a plurality of filtered parameters such as body type, height, age, gym location, etc. Further, there is a long felt need in the art for a dating app that offers a way to date and meet with like-minded users, such as fitness enthusiasts. Finally, there is a long felt need in the art for a dating app that allows a user to seek out other users for the purposes of friendship, a relationship, a pen pal, a gym partner, etc.

The subject matter disclosed and claimed herein, in one embodiment thereof, comprises a mobile dating software application. More specifically, the mobile software dating application is an improved dating app which allows a user to seek out another user for the purposes of friendship, a relationship, a pen pal, a gym partner, etc. The dating app allows fitness enthusiasts and other users to create a profile using facial recognition software to ensure that the users upload only photos of themselves. The dating app includes a video and text chat function that can be used after matching with another user to speak with them. Additionally, the dating app includes a filtering system to filter users via criteria such as, but not limited to, body type, height, age, ethnicity, religion, gym location, location from user, etc.

In this manner, the novel dating app of the present invention accomplishes all of the foregoing objectives and provides an effective way to date and meet with like-minded users, such as fitness enthusiasts. The present invention offers a dating app which allows fitness enthusiasts and other users to create a profile using facial recognition software to ensure that users upload only photos of themselves, and the app allows a user to seek out another user for the purposes of friendship, a relationship, a pen pal, a gym partner, etc.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for matching users. The matching of users is done for the purposes of friendship, a relationship, a pen pal, a gym partner, etc. The system includes a computer-implemented application installed on a user device, and a server coupled to a database. The computer implemented application provides an interface operable to electronically receive a user registration request of one or more self-pictures, to electronically receive a video of the user using the camera of the user device and to electronically receive a motion of the user device. The server compares the photo taken with the camera and the uploaded self-pictures with a camera preview background snapshot for facial recognition and face matching, and then compares the motion detected by the camera preview to the generated random motions to check the authenticity of the user. A processor of the server is further configured to determine a set of potential matches from the plurality of user profiles for the user, causing the interface to display a list of potential matches to the user, electronically receive a swipe up gesture on a first profile from the list of user profiles, wherein the swipe up gesture indicates disliking the user profile, or electronically receive a swipe down gesture on a second profile from the list of user profiles, wherein the swipe down gesture indicates liking of the user profile, and wherein the liked profiles and the disliked profiles are stored in the database. The processor further removes the disliked profiles from the list of the displayed profiles and enables a communication between the user and the liked user profiles.

In a further embodiment of the present invention, a computer-implemented method for matching users based on their profiles is described. The method includes the steps of electronically receiving a plurality of user profiles, wherein each profile has profile photos, full name, bio, birthdate, height, gender, dating interests, spirituality interests, fitness type and ethnicity of the respective user. The method further displays, on a graphical user interface of a user device, a list of potential matches based on the similarity of the profiles, receives a swipe down gesture on a profile from the list of matches, wherein the swipe down gesture indicates liking the user profile, and receives a swipe up gesture on a second profile from the list of matches, wherein the swipe up gesture indicates disliking the user profile. In response to receiving said swipe up or swipe down gestures, the method determines if the user can chat with the liked user profiles, and in response to this determination, the method enables a text chat or video chat between the user and the liked user profiles, wherein the determining is based on the subscription level of the user.

In yet another embodiment of the present invention, the method further comprises upgrading a subscription level by the user, allowing more options for finding the right match and enabling communication with the matches.

In yet another embodiment of the present invention, the graphical user interface displays a home page that has a flex mode button, which when pressed enables the user's profile to show readily to other users within a specific geographical area, a rewind button that allows the user to go back to a previous profile that was swiped up, a crushing button allows the user to emphasize how strong the user likes the potential match and a full profile button the shows the full profile details of the matches. These features are available to the user based on the subscription level purchased.

In yet another embodiment of the present invention, a non-transitory computer-readable medium comprising instructions is disclosed. The non-transitory computer-readable medium comprising instructions is executed by a processor and configured to electronically receive user profile parameters for building a user profile, authenticating the user during signing up, receiving profile parameters using face matching and motion detection, and upon successful authentication displaying a home page to the user, displaying a list of potential matches wherein the user can swipe up or swipe down on each profile from the list of potential matches, electronically receiving the swipe up or swipe down gesture and pressing a filter button to set filters such as gender, dating interests, height, fitness type, etc., for displaying the user profiles in the list of potential matches.

The processor further allows the user to change the registered phone number, registered email and registered password for accessing the application. The processor further displays a Discover tab that when clicked, causes the processor to electronically receive profiles for matching based on the user profile data, such as fitness preferences and interests.

The advantage of the system and method of the present invention is that it provides a secure and trusted meeting and dating facility for users having similar fitness interests and other similar likings. The application authenticates users before allowing them to use the application and thus increases the authenticity of the users using the application. The authentication process eradicates bots and fake profiles.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 is a schematic diagram illustrating one embodiment of the fitness enthusiast dating system of the present invention for enabling secure meetings and dates among registered users in accordance with the disclosed architecture;

FIG. 2 illustrates a block diagram of the server system for the fitness enthusiast dating system of the present invention in accordance with the disclosed architecture;

FIG. 3 illustrates an exemplary main page/home page for the Fitmatch software application installed on a user device in accordance with the disclosed architecture;

FIG. 4 represents an exemplary flow chart that illustrates the steps of a method performed by the Fitmatch software application and the server to enable secure meetings and dates among registered users using the system of the present invention in accordance with the disclosed architecture;

FIG. 5 illustrates a flow diagram showing the exemplary steps performed in initiating operation of the Fitmatch software application of the present invention in accordance with the disclosed architecture;

FIG. 6 illustrates a flow diagram showing operation of providing login and sign up options for the users as part of the authentication flow in the Fitmatch application of the present invention in accordance with the disclosed architecture;

FIG. 7 illustrates a flow diagram showing an exemplary operation of the login process for the Fitmatch software application of the present invention in accordance with the disclosed architecture;

FIG. 8 illustrates a flow diagram showing the exemplary operation of the signup process of a user for signing up for the Fitmatch software application of the present invention for seeking out other users in accordance with the disclosed architecture;

FIG. 9 illustrates a flow diagram showing the steps performed when a user forgets his or her password of the Fitmatch app of the present invention in accordance with the disclosed architecture;

FIG. 10 illustrates a block diagram showing various membership levels/subscriptions offered in the Fitmatch application of the present invention in accordance with the disclosed architecture;

FIG. 11 illustrates a block diagram showing the various profile parameters that can be edited by a user using the edit profile button option in the Fitmatch application of the present invention in accordance with the disclosed architecture;

FIG. 13 illustrates a flow diagram showing an operation of changing a user's password in the Fitmatch software application of the present invention in accordance with the disclosed architecture;

FIG. 14 illustrates a flow diagram showing an operation of changing a user's registered email address in the Fitmatch software application of the present invention in accordance with the disclosed architecture;

FIG. 15 illustrates a flow diagram showing an operation of changing a user's registered phone number in the Fitmatch software application of the present invention in accordance with the disclosed architecture;

FIG. 16 illustrates a flow diagram showing an operation of managing different types of notifications using the manage notification button in the Fitmatch application of the present invention in accordance with the disclosed architecture;

FIG. 17 illustrates a flow diagram showing an operation of a user logging out from the Fitmatch application of the present invention in accordance with the disclosed architecture;

FIG. 18 illustrates a flow diagram showing an operation of a user deleting the Fitmatch application account of the present invention in accordance with the disclosed architecture;

FIG. 19 illustrates a flow diagram showing the exemplary steps performed for liking or disliking a profile when viewed from the list shown on the Fitmatch application of the present invention in accordance with the disclosed architecture;

FIG. 20 illustrates a flow diagram showing the actions performed when pressing the crushes tab/button on the homepage of the Fitmatch software application of the present invention in accordance with the disclosed architecture;

FIG. 21 illustrates the flow diagram showing the options and steps performed when the chat tab on the homepage of the Fitmatch software application is pressed in accordance with the disclosed architecture; and

FIG. 22 illustrates an exemplary user device that is used for installing the Fitmatch software application of the present invention for communication with the server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exist a long felt need in the art for a system and method that allows users, especially fitness enthusiasts, to create a profile and match with other users for dating and friendship purposes. There is also a long felt need in the art for a system and method that ensures that the user is not fake and creates a true and relevant profile. Additionally, there is a long felt need in the art for a dating app that enables users to seek out other users based on a plurality of filtered parameters such as body type, height, age, gym location, etc. Further, there is a long felt need in the art for a dating app that offers a way to date and meet with like-minded users, such as fitness enthusiasts. Finally, there is a long felt need in the art for a dating app that allows a user to seek out another user for the purposes of friendship, a relationship, a pen pal, a gym partner, etc.

The present invention, in one exemplary embodiment, is a novel mobile dating software application. More specifically, the mobile software dating application is an improved dating app that allows a user to seek out another user for the purposes of friendship, a relationship, a pen pal, a gym partner, etc. The dating app allows fitness enthusiasts and other users to create a profile using facial recognition software to ensure the user uploads only photos of themselves. The dating app includes a video and text chat function that can be used after matching with another user to speak with them. Additionally, the dating app includes a filtering system to filter users via criteria such as, but not limited to, body type, height, age, ethnicity, religion, gym location, location away from user, etc.

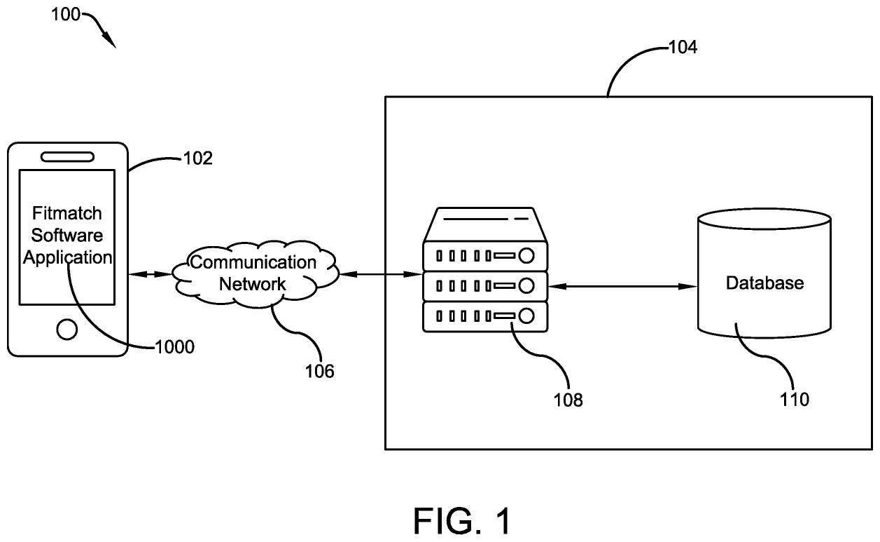

Referring initially to the drawings, FIG. 1 is a schematic diagram illustrating one embodiment of the fitness enthusiast dating system 100 of the present invention for enabling secure meetings and dates among registered users. The system 100 of the present invention is configured to facilitate a fitness enthusiast and any other authorized user to seek out another user for the purposes of finding a friendship, a relationship, a pen pal, a gym partner, etc., in a secure and efficient manner. More specifically, the system 100 has a client-server architecture wherein a user accesses the system 100 and its offerings through a Fitmatch software application 1000 installed on a user device 102. The system 100 also comprises a server system 104 and the user device 102 is communicatively-coupled to the server system 104 via a communication network 106, such as the Internet. The user device 102 is capable of facilitating a user to input data, receive data and/or transmit data within the system 100 using the Fitmatch software application 1000. It will be apparent to a user of ordinary skill in the art that the user may be any personnel using the system 100 for connecting with other users having similar likes or dislikes, without deviating from the scope of the disclosure. Examples of the user device 102 may include, but are not limited to, a desktop, a notebook, a laptop, a handheld computer, a touch-sensitive device, a computing device, a smart-phone, and/or a smart watch, etc., or any other suitable device as is known in the art.

The server system 104 is a network of computers, a software framework or a combination thereof, that may provide a generalized approach to creating the server implementation. More specifically, the server system 104 includes an application server 108 and one or more associated databases 110. The application server 108 and the database 110 can be integrated as a single unit, or can be coupled to each other through a network. Examples of the application server 108 may include, but are not limited to, personal computers, laptops, minicomputers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web-framework, a .NET framework, a personal home page (PHP) framework, or any web-application framework, etc. The server system 104 can be maintained by a storage facility management authority or a third-party entity that facilitates service enablement and resource allocation operations of the system 100.

The application server 108 is configured to have the logic, instructions, circuitry, interfaces, and/or codes for executing various operations required for communication between the server 108 and the user device 102, and also between the database 110 and the server 108. The database 110 is configured to store therein, data associated with users registered with the system 100. The data associated with the users may include, but is not limited to, name, age, gender, fitness preferences, body type, height, weight, ethnicity, religion, gym location, location away from user, etc., or any other suitable data as is known in the art. Embodiments of the present disclosure are intended to include and/or otherwise cover any type of data associated with the users registered with the system 100. Examples of the database 110 may include but are not limited to, a relational database, object oriented database, cloud database, object storage, block storage, etc. In some embodiments, a set of centralized or distributed network of peripheral memory devices may be interfaced with the server 104, for example on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the user device 102 and the server system 104. The communication data may be transmitted or received via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols or any combination thereof.

In one embodiment, the communication data may be transmitted or received via at least one communication channel or a plurality of communication channels in the communication network 106. The communication channels may include, but are not limited to, a wireless channel, a wired channel, or a combination of wireless and wired channels thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network or a combination thereof. Embodiments of the present invention are intended to include or otherwise cover any type of communication channel, including known, related art and/or later developed technologies.

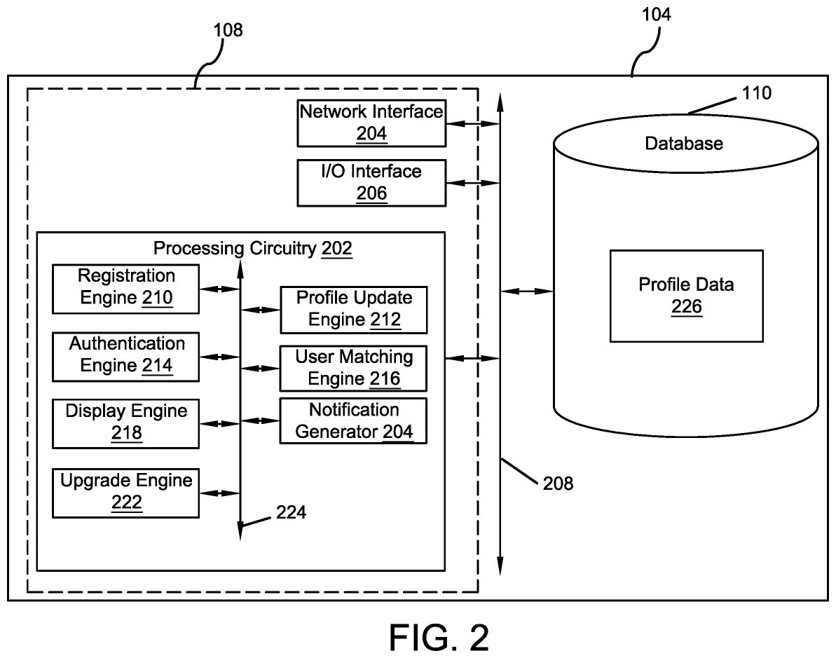

FIG. 2 illustrates a block diagram of the server system for the fitness enthusiast dating system of the present invention. As stated earlier, the server system 104 includes an application server 108 and one or more databases 110. The application server 108 includes the processing circuitry 202. The server 108 further includes a network interface 204 and an input/output (I/O) interface 206. The processing circuitry 202, the database 110, the network interface 204 and the input/output (I/O) interface 206 communicate with each other by way of a first communication bus 208. The processing circuitry 202 may include a registration engine 210, a profile update engine 212, an authentication engine 214, a user matching engine 216, a display engine 218, a notification engine 220 and an upgrade engine 222 that communicate with each other by way of a second communication bus 224. It will be apparent to a user having ordinary skill in the art that the application server 108 is for illustrative purposes only and is not limited to any specific combination of hardware circuitry and/or software.

The database 110 includes suitable logic, instructions, interfaces and/or codes to store registration data associated with the users registered with the system 100. The network interface 204 may include suitable logic, circuitry and interfaces that may be configured to establish and enable a communication between the server 104 and the different components of the system 100 such as the user device 102, via the communication network 106.

The I/O interface 206 may include suitable logic, circuitry, interfaces and/or code that may be configured to receive inputs (i.e., orders) and transmit server outputs via a plurality of data ports in the server 108. The I/O interface 206 may include various input and output data ports for different I/O devices.

The processing circuitry 202 can be configured to perform the user matching and dating operations by way of the registration engine 210, the profile update engine 212, the authentication engine 214, the user matching engine 216, the display engine 218, the notification generator 220 and the upgrade engine 222. In an embodiment, the registration engine 210 is configured to enable the users to register into the system 100 by providing registration or profile data 226 through a registration menu (not shown) of the fit match application installed on the user device and displayed through the user device 102. The registration/profile data 226 may include, but is not limited to, a body type, a height, an age, an ethnicity, a religion, a gym location, a workout preference, etc., or any other suitable data as is known in the art. In some embodiments, the registration data further includes registration photographs of the user. Embodiments of the present disclosure are intended to include or otherwise cover any type of registration data.

In some embodiments, the registration engine 210 can be configured to face match the photograph taken with a phone camera (not shown) initially with a camera preview background snapshot. The registration engine 210 can be configured to utilize a facial recognition and/or a face matching algorithm to match the photographs uploaded by the user. Further, the registration engine 210 can be configured to utilize a motion verification technique, such that the registration engine 210 generates random motion to be detected via the phone camera preview and is utilized to verify an authenticity of the user. In an embodiment, when the registration engine 210 determines that the authentication based on the facial recognition and/or the face matching algorithm and the motion verification technique is successful, then the registration engine 210 can be configured to generate a successful login notification that can be displayed through the registration menu as a pop-up notification. In another embodiment, when the registration engine 210 determines that the authentication based on the facial recognition and/or the face matching algorithm and the motion verification technique is unsuccessful, then the registration engine 210 can be configured to generate a failed login notification that can be displayed through the registration menu as a pop-up notification. The registration engine 210 can be further configured to enable users to create a login identifier and a password that enables users to subsequently login into the system 100. The registration engine 210 can be configured to store the registration/profile data 226 associated with the users and the login and password associated with the user in a Look Up Table (LUT) (not shown).

The profile update engine 212 can be configured to enable the users registered with the system 100 to update details, such as data provided during registration and add additional photographs. In some embodiments, the profile update engine 212 can be configured to enable the user to update data and upload additional photographs through a profile update menu of the fit match application displayed through the user device 102. In some embodiments, the profile update engine 212 can be configured to enable the user to upload photographs in picture formats such as, but not limited to, a Joint Photographic Experts Group (JPG), a Portable Network Graphics (PNG), a Graphics Interchange Format (GIF), a Tagged Image File (TIFF), Photoshop Document (PSD), etc. Further, the profile update engine 212 can be configured to transmit the photographs to the authentication engine 214 when the photographs are uploaded to a maximum of 80%.

The authentication engine 214 is configured to perform image processing and run facial algorithms to check the authenticity of the match of the uploaded photographs. The authentication engine 214 compares the uploaded image with a live video recording of the user while uploading the picture, thereby preventing fake profiles and bots. Further, the authentication engine 214 can be configured to utilize an image-processing technique and facial recognition algorithm to match the uploaded photographs with the registration photographs of the users, submitted by the users during the registration process. If the authentication engine 214 successfully authenticates the uploaded photographs, then an upload success notification is generated. In cases of unsuccessful authentication, the authentication engine 214 generates an upload failure notification. The authentication engine 214 provides the generated upload success notification and the upload failed notification to the notification engine 220.

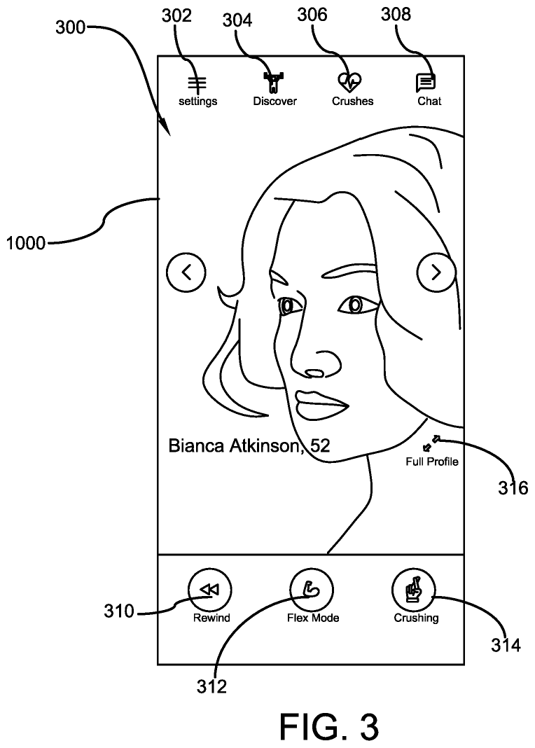

The user matching engine 216 enables the users to select a set of criteria to search for a match using a preferred match criteria menu. In some embodiments, the user matching engine 216 can be configured to enable the user to select the set of criteria including, but not limited to, a body type, a height, an age, an ethnicity, a religion, a gym location, workout preferences, a distance from the user gym location, etc. Embodiments of the present disclosure are intended to include or otherwise cover any type of details in the set of criteria. Once the user selects the set of criteria and activates a discover tab (as shown in FIG. 3), the user matching engine 216 identifies and selects user profiles registered with the system 100 that match the set of criteria entered by the user. The user matching engine 216 filters out previously swiped profiles by the user and fetches a predefined number of profiles at once. The predefined number of user profiles may be in a range from about ten to about hundred. Further, once the user profiles are identified based on the set of criteria entered by the user, the user matching engine 216 can be configured to transmit the identified user profiles to the display engine 218.

The display engine 218 can be configured to display the identified user profiles as stacked cards through a main menu (as shown in FIG. 3) displayed through the user device 102. The display engine 218 may be further configured to enable the user to swipe up and swipe down the user profiles displayed through the main menu. In an embodiment, when the user swipes down for a user profile, the user profile may be added to a list of liked user profiles and stored in the database 110. Similarly, when the user swipes up for a user profile, the user profile is added to a list of disliked user profiles and stored in the database 110. The display engine 218 ensures that the user profiles already swiped by the user are not displayed again as the identified user profiles. In some embodiments, the display engine 218 may be configured to match the identified user profiles received from the user matching engine 216 with the user profiles stored in the database 110 to further identify new user profiles from the identified user profiles that do not match with the user profiles.

The upgrade engine 222 can be configured to enable users to upgrade the profile by selecting one of the plurality of subscription types offered by the present invention. For example, a platinum membership, a Flex mode subscription, a Beast mode membership and a Juices mode membership are provided to the users. In some embodiments, the upgrade engine 222 enables the users to link their social media accounts with their user profiles. The social media accounts may include, but are not limited to, Instagram®, Facebook®, Twitter®, etc. Embodiments of the present disclosure are intended to include or otherwise cover any type of social media account known in the art.

FIG. 3 illustrates an exemplary main page/home page 300 of the Fitmatch software application 1000 installed on a user device 102. The main page 300 provides a settings tab 302, a discover tab 304, a crushes tab 306, a chat tab 308, a rewind tab 310, a flex mode tab 312, a crushing tab 314 and a full profile tab 316. In the illustrated embodiment, the settings tab 302 enables the user to update the profile data. An edit profile button within the settings tab 302 allows the user to change the profile data that may include, but is not limited to, the profile photos, full name, bio, birthdate, height, gender, etc. Further, the user can also edit dating interests, spirituality, fitness type, ethnicity, etc. The settings tab 302 also allows the user to select an appropriate membership plan offered by the system of the present invention. When a user chooses to select a plan in the settings tab 302, a plurality of plans are shown to the user. The desired filter parameters can also be customized by the user from the settings tab 302. Settings relate to message notifications, matching notifications and changing login credentials, such as password or email changes that are modified from the settings tab 302.

The discover tab 304 enables the users to search for preferred user profiles based on the set of criteria entered. As a process, post login, the user's profile data is retrieved from the database, and is processed on the server end with the filters specific to the logged in user. The server then categorizes user profile data based on his or her fitness preferences and interests, and lists profiles from the server on which users can swipe up or swipe down. The crushes tab 306 displays a list of users who liked the logged in user. It should be noted that for revenue generation and business methods, the crushes tab 306 is a subscriber-based tab that is visible and accessible if the user has a premium subscription or has paid specifically for this feature. Further, the chat tab 308 displays the inbox of the user. The application 1000 enables users to chat with the user profiles that have been matched to their criteria. The chat tab 308 enables users to initiate a text or video chat with the matched user profiles. The chat tab 308 provides a sub navigation bar containing a horizontal list of matches with whom the user has not started to chat.

Further, the rewind tab 310 enables the users to rewind swipe to a previous swiped user profile of the user profiles displayed through the main menu 300, in case the users feels that they mistakenly swiped up the profile. The flex mode tab 312 is configured to enable the users to boost their profile to put them at the top of the line. In other words, the flex mode button 312 may be configured to enable the user to prioritize their profile by making it visible on top of the list of the preferred user profiles. For example, upon pressing the flex mode button 312, the user's profile is shown readily to other users based on matched criteria. The crushing button 314 enables users to super like the user profiles that the user likes the most. The crushing button 314 allows users to emphasize how strongly they like their potential match. This action places the users at the top of their crushes match list. The full profile tab 316 enables users to view details associated with the profile displayed on the main page 300. Upon pressing the full profile expand button 316, the potential match profile details are shown on the subsequent page or can be shown on the main page 300.

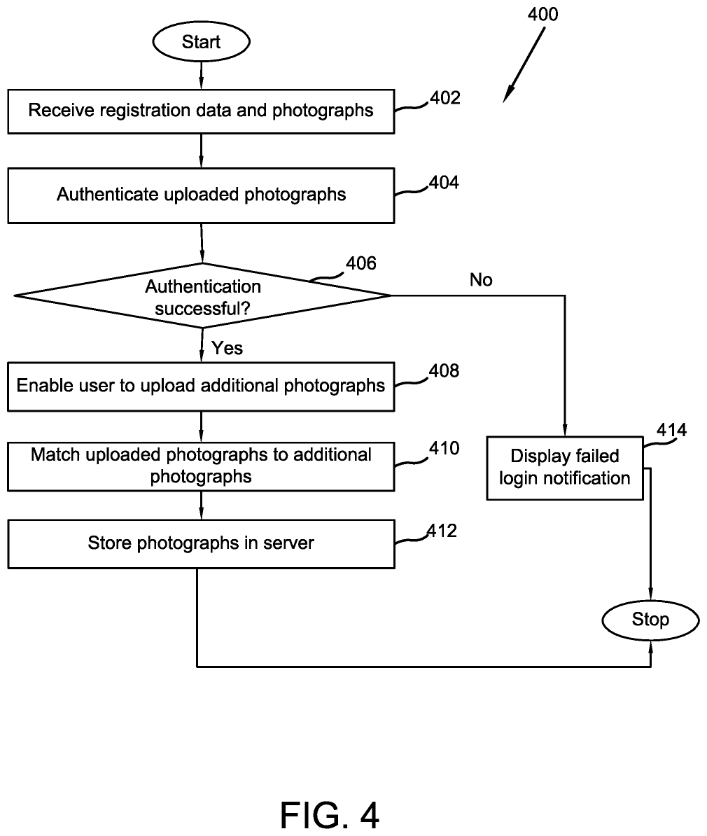

FIG. 4 represents an exemplary flow chart that illustrates the steps of a method 400 performed by the Fitmatch software application 1000 and the server 104 to enable secure meetings and dates among registered users using the system 100 of the present invention. Referring now to FIG. 4, the method 400 generally starts at step 402, where the application server 104 receives the registration or profile data and the photographs of the user. At step 404, the server 104 authenticates the uploaded photographs by using facial recognition algorithms and motion detection techniques to ensure the user is real and is not using fake profiles or bots.

At step 406, if the server 104 determines that the authentication is successful, then the method 400 may proceed to step 408, otherwise the method may proceed to step 414. At step 408, the server 104 enables the user to upload additional photographs by using the fit match application 1000. At step 410, the server 104 matches the uploaded photographs with the photographs provided during registration to ensure the photographs uploaded are associated with the same user. In some embodiments, the server 104 may be configured to match the uploaded photographs with the photographs provided during registration when the upload is 80% complete. At the step 412, the server 104 stores the photographs in the database 110. Further, in case the authentication is unsuccessful at step 406, then a failed login notification is displayed at step 414.

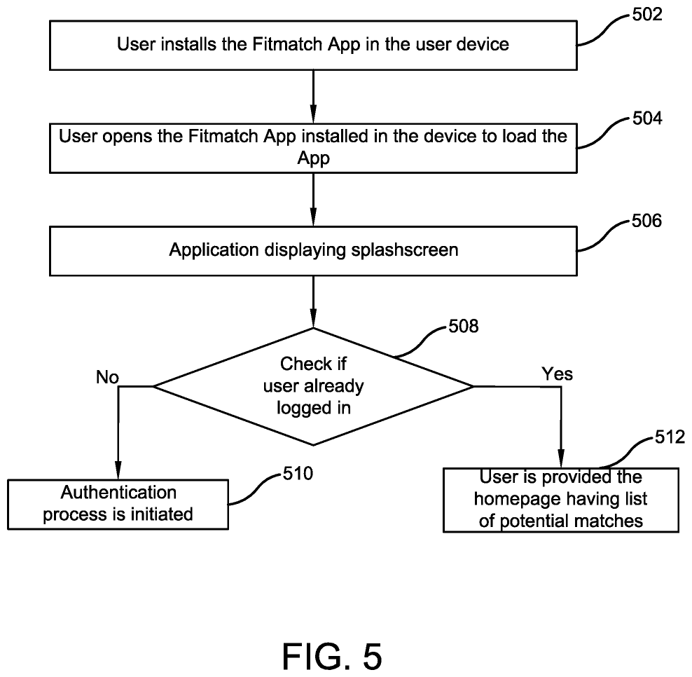

FIG. 5 illustrates a flow diagram showing the exemplary steps performed in initiating operation of the Fitmatch software application of the present invention. As shown in FIG. 5, initially at 502, a user installs the Fitmatch software application on his or her user device. The application can be downloaded from a playstore such as Google playstore, Apple playstore, etc. Once the application is installed on the user device, at 504 the user opens the Fitmatch software application by pressing its corresponding icon on the interface of the electronic device in order to load the Fitmatch app. When the application is activated, at 506 a splash screen showing the icon of the application is displayed to the user. Then at 508, the Fitmatch app (along with its communication with the server) determines whether the user is already logged in or not. If it is determined that the user is not logged in, then at 510, the authentication process is initiated. Further, at 508, if it is determined that the user is already logged in, then at 512, the user is provided with the homepage/main page having the list of the potential matches and other buttons for navigating through the application. The homepage allows the user to swipe up and swipe down to dislike and/or like the potential matches.

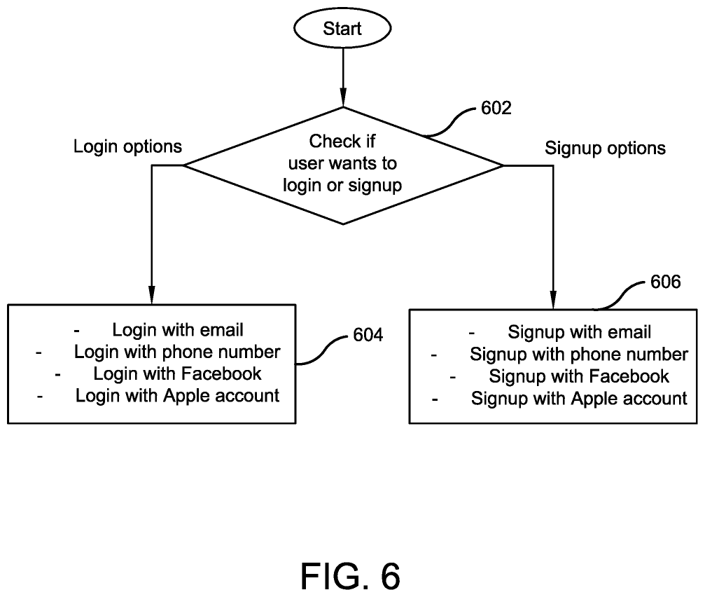

FIG. 6 illustrates a flow diagram showing the operation of providing login and sign up options for the users as a part of an authentication flow in the Fitmatch application of the present invention. During the authentication process, the Fitmatch app performs facial recognition and motion detection and when the authentication is complete and successful, the user can then proceed to complete the signup process. The steps shown in FIG. 6 are initiated at post step 510 of the process shown in FIG. 5. As a part of authentication, after the splash screen, at 602 it is determined whether the user wants to perform login or signup in the Fitmatch app. If it is determined that the user needs to login to the Fitmatch app, then at 604, the app provides a plurality of options for the user to login into the application. The user can login using one of a registered email, a registered phone number, a Facebook profile or an Apple account. Further, at 602, if it is determined that the user needs to sign up to the Fitmatch app, then at 606, the application provides a plurality of options for the user to sign up into the application. Specifically, the user can sign up using one or more of an email, a phone number, a Facebook profile, an Apple account, etc. It should be noted that any other method or means for signing up or logging in to the application can be added in the system as per the needs and/or desires of the users. Further, during signing up, the user creates a profile by providing information such as profile photos, full name, bio, birthdate, height, gender, etc. Further, dating interests, spirituality, fitness type (such as body building, athletics, sports, etc.) and ethnicity, etc., can be added. When the user signs up using a social media account, such as Facebook, all the profile parameters can be incorporated to build an automatic profile of the user.

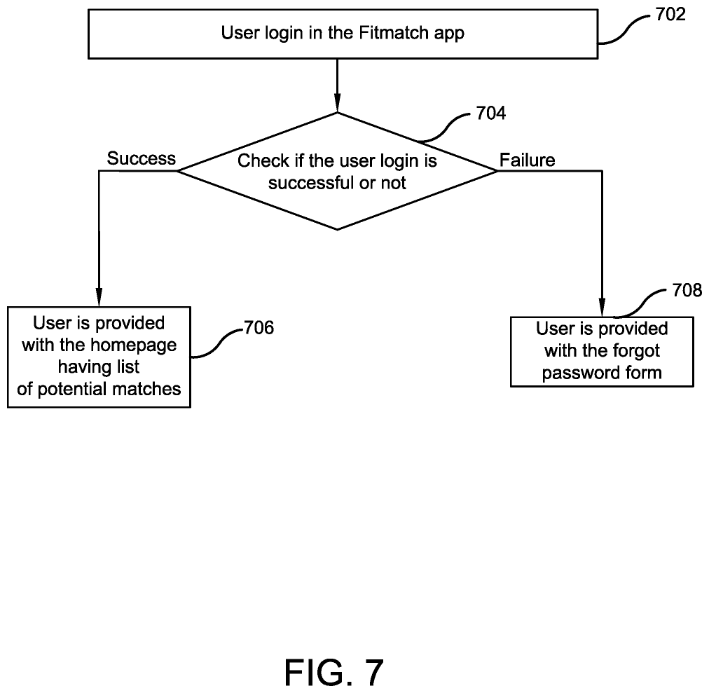

FIG. 7 illustrates a flow diagram showing an exemplary operation of the login process to the Fitmatch software application of the present invention. As shown in FIG. 7, at 702 a user performs the login operation by providing the password entered at the time of the signup process in the Fitmatch app. Then at 704, the Fitmatch application checks if the user login is successful or not by comparing the received credentials with the stored credentials in the database of the system. If it is determined that the user login is successful, then at 706, the user is provided with the homepage having the list of the potential matches and other control buttons as shown in FIG. 3. The homepage allows the user to swipe up and swipe down to dislike and like the potential matches. Further at 704, if it is determined that user login is not successful, then at 708, the user is provided with the forgot password form to reset the password.

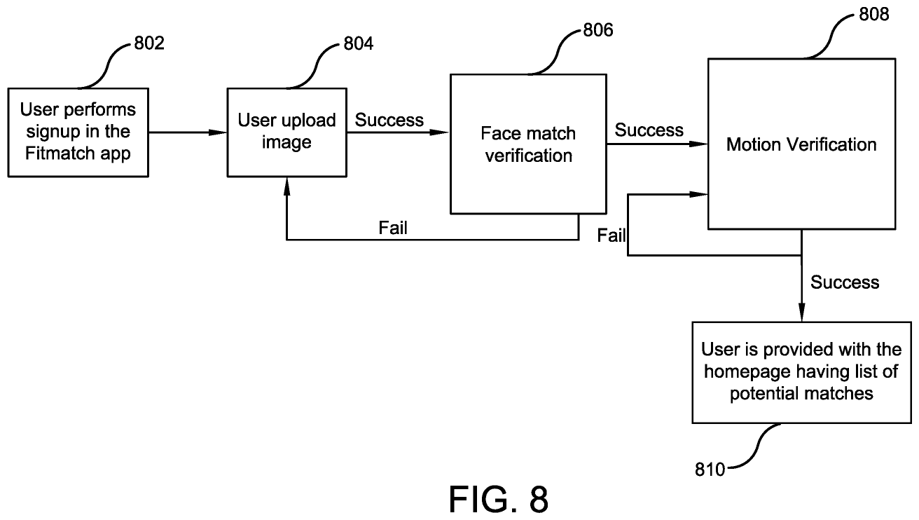

FIG. 8 illustrates a flow diagram showing the exemplary operation of the signup process of a user for the Fitmatch software application of the present invention. As shown in FIG. 8, at 802 the user performs the signup operation in the Fitmatch app by pressing the signup button, or filling out the signup form provided by the application on the splash screen. Then at 804, the user uploads one or more images for the authentication process. If the images are uploaded successfully (meaning that the server receives the images), then at 806, the Fitmatch app performs the face matching step to compare uploaded photos and to ensure the user has uploaded photos of him or herself and not of any other profile. Further, at 806, if face matching is unsuccessful, then the Fitmatch app asks the user to upload the images again. This authentication step is important as it prevents fake profiles on the system and thus, improves the legitimacy of the profiles. Once the face matching verification process is successfully completed, then at 808, the Fitmatch app uses a second step of authentication in the form of the motion detection technology to detect the motion executed by the user from the camera view and to check if the motion matches the suggested motion randomly generated by the server to verify the user. Once the motion detection verification process is successfully completed, then at 810, the user successfully passes the authentication via having a profile created for the user, and the user is then provided with the homepage showing a list of potential matches. Further, at 808, if motion detection verification is unsuccessful, then the Fitmatch app asks the user to again perform the motion detection verification process. It should be noted that the profile parameters are entered by the user only after both authentication steps are successfully performed by the user.

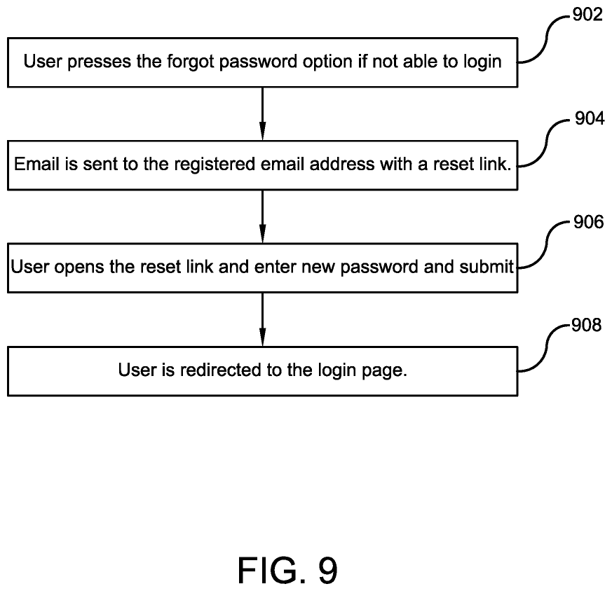

FIG. 9 illustrates a flow diagram showing the steps performed when a user forgets his or her password for the Fitmatch app of the present invention. As shown in FIG. 9, at 902 the user presses the forgot password option if the user forgets the password and is unable to login to the Fitmatch application. At 904, as the user presses the forgot password option, an email is sent to the registered email address with a reset link. The user may be asked to input the registered email for adding an additional step of security while resetting the password. Then at 906, the user opens the reset link to reset the password and submit the new password for login. Once the password is successfully submitted by the user, then at 908, the user is redirected to the login page and the user can login using the new password.

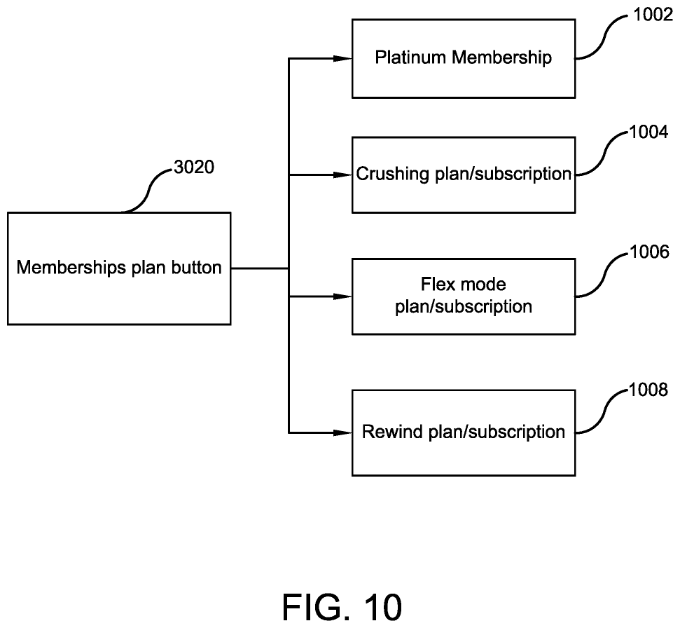

FIG. 10 illustrates a block diagram showing the various membership/subscriptions offered in the Fitmatch application of the present invention. As shown in FIG. 10, a membership plan button 3020 accessed in the settings tab 302, displays a plurality of memberships that a user can choose from. Users can also change their subscriptions as per their preferences. When the membership plan button 3020 is pressed by the user, a next view displays the offered subscription/membership plans. A platinum membership plan 1002 upgrades the app to a platinum membership that enables the user to access all the premium features (such as crushing, rewind, etc.) of the Fitmatch app. The crushing plan 1004 displays the list of other users who have liked the user. This is an important feature as the user becomes aware of the other potential matching users. The flex mode subscription 1006 boosts the profile of the user and puts the user at the top of the line. The rewind subscription 1008 enables the user to rewind the previous swipe, if the user has swiped “Don't like” by accident. It should be appreciated that different types of the subscriptions/memberships offer different levels of use of the application, and provide enhanced functionality and utility to the users. The settings tab 302 as shown in FIG. 3 is pressed to access the membership plan button 3020 and based on the membership selection by the user, a corresponding cost is shown and after paying the subscription cost the user accesses and enjoys the corresponding features of the application.

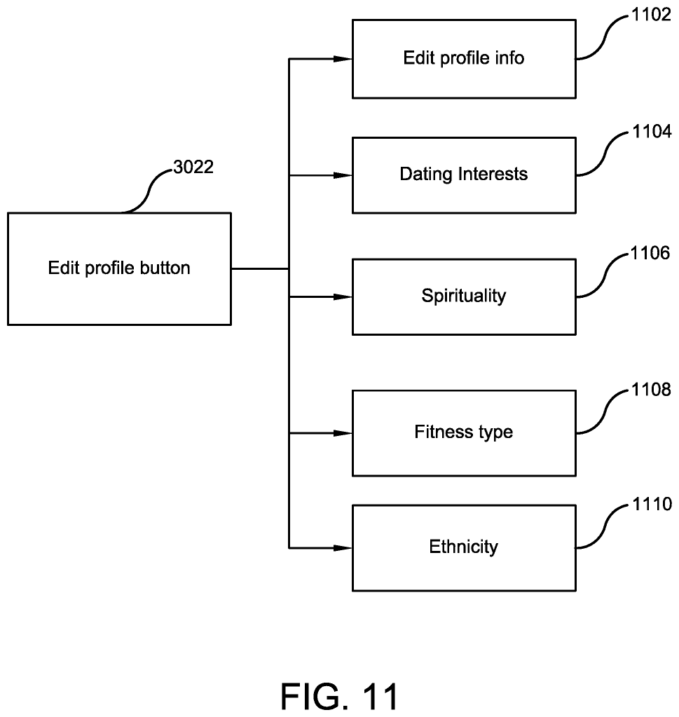

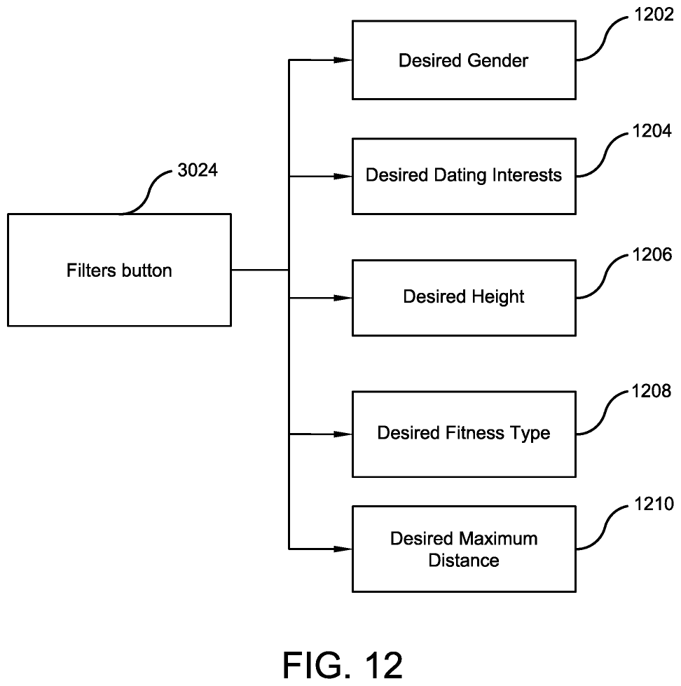

FIG. 11 illustrates a block diagram showing the various profile parameters that can be edited by a user using the edit profile button option. The edit profile button 3022 is accessible within the settings tab, and can be accessed by pressing the settings tab. The edit profile button 3022 enables the user to edit user profile information 1102 that includes parameters such as profile photo, full name, birth date, gender, height, biography, etc. The edit profile button enables users to edit their dating interests 1104, such as fitness interests, workout preferences, etc, or any other interests as are known in the art. The edit profile button provides a user with an option to edit spirituality practices 1106, such as prayer, meditation, breathing exercises and other such types of spiritual practices. The edit profile button also provides user with an option to edit the fitness type 1108, such as bodybuilding, cardio, CrossFit, etc., that he or she practices. The edit profile button also provides an ethnicity option 1110 that enables a user to update information about his or her ethnic background.

FIG. 12 illustrates a block diagram showing the various filter parameters offered by the Fitmatch app of the present invention. The filters button 3024 within the settings button displays various filters that can be customized by a user. The filters allow the user to filter out the user profiles that do not match with the required criteria of the user. The filters can be displayed in the form of a drop-down menu, a grid form or any other suitable form as is known in the art. The filters can also be updated based on the subscription level of the user. The desired gender option 1202, with options of “Male”, “Female” or “Transgender” are provided to the user for selection. The desired dating interests 1204 can have options like blind date, etc. The desired height filter 1206 has various height selection options for all the users. The desired fitness type filter option 1208 provides sub-options such as cross-fit, athletic, body building, etc. In order to find matches and user profiles within a specific distance, the filter option of maximum desired distance 1210 is provided to the users. The application uses the GPS location of the user device for detecting a current location of the user, and then based on the filtered maximum distance, the user profiles within the specified maximum distance are displayed to the user.

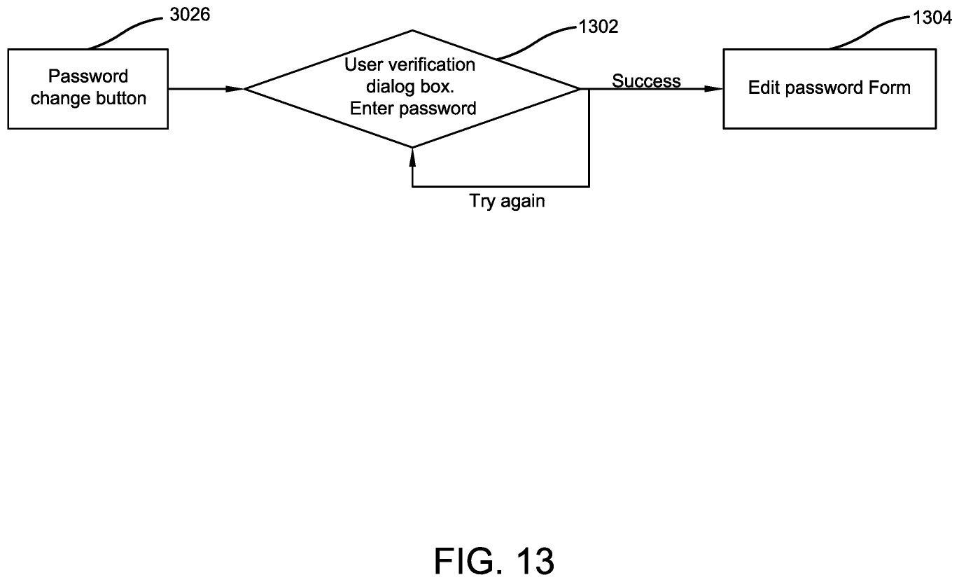

FIG. 13 illustrates a flow diagram showing the operation of changing a user's password in the Fitmatch software application of the present invention. The password change button 3026 within the settings tab 302 provides users with an option to change the password and set a new password. When the user presses the change password button 3026, then at 1302, the Fitmatch application provides a verification dialog box for the user to enter the current password for verification purposes. Once the password is successfully entered, then at 1304, the user is provided with an edit password form that enables the user to set the new password for the Fitmatch account. Further, at 1302, if the current password is not successfully entered, then, the user has to re-enter the current password for verification purposes before resetting the password.

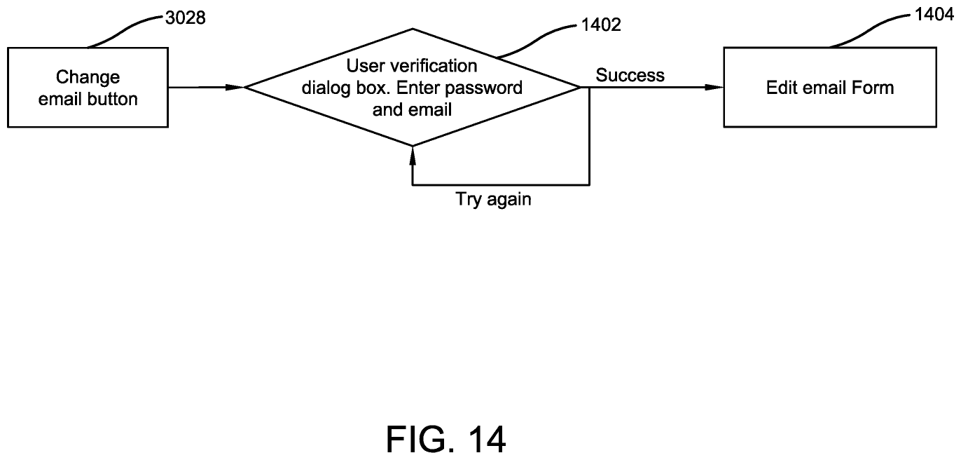

FIG. 14 illustrates a flow diagram showing the operation of changing a user's registered email in the Fitmatch software application of the present invention. The email change button 3028 within the settings tab 302 provides users with an option to change the registered email or also a secondary email. At 11402, when the user presses the email change button 3028, the Fitmatch application provides a verification dialog box for the user to enter the current email and password for verification purposes. Once the current registered email and the current password is successfully entered, then at 1404, the user is provided with an edit email form that enables the user to set the new registered email for the Fitmatch account. Further, at 1402, if the current email or the password is not successfully entered, then, the user has to re-enter the current registered email for verification purposes before resetting the registered email.

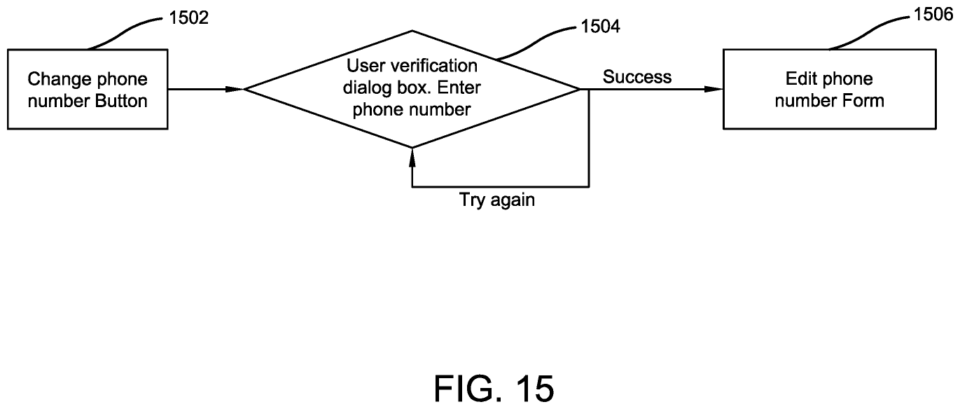

FIG. 15 illustrates a flow diagram showing the operation of changing a user's registered phone number in the Fitmatch software application of the present invention. The phone number change button 1502 within the settings tab 302 provides users with an option to change the registered phone number or also a secondary phone number. At 1504, when the user presses the phone number change button 1502, the Fitmatch application provides a verification dialog box for the user to enter his or her current registered phone number and password for verification purposes. Once the current registered phone number and password are successfully entered, then at 1506, the user is provided with an edit phone number form that enables the user to set the new registered phone number for the Fitmatch account. Further, at 1504, if the current phone number or the password is not successfully entered, then, the user has to re-enter the current registered phone number for verification purposes before resetting the phone number.

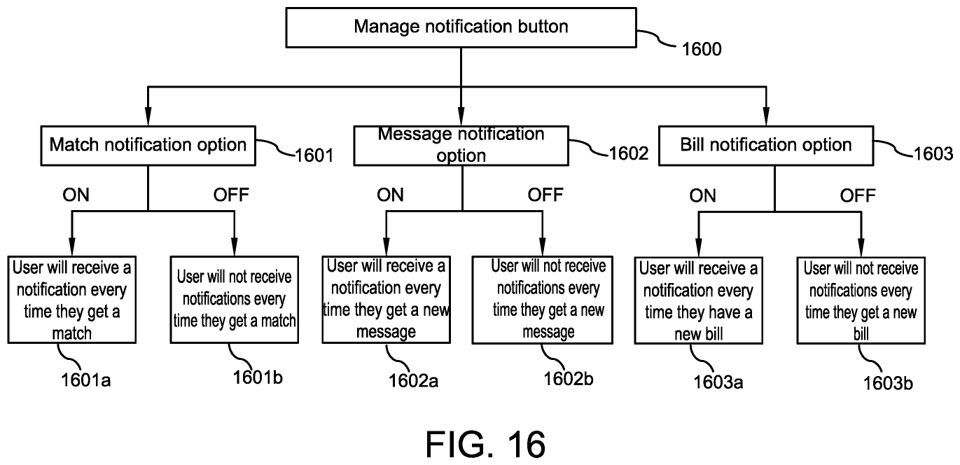

FIG. 16 illustrates a flow diagram showing the operation of managing different types of notifications using the manage notification button 1600 accessed by pressing the setting button 302 in the Fitmatch application of the present invention. As shown in FIG. 16, the manage notification button 1600 provides users with options for managing different types of messages or notifications offered by the Fitmatch application of the present invention. The match notification option 1601 enables users to manage match notification options, which allows users to enable or disable match notifications of the potential profiles. If the match notification option is turned on, then at 1601a, the user will receive notifications every time he or she gets a match. If the match notification option is turned off, then at 1601b, the user will not receive notifications when he or she gets a match.

The message notification option 1602 allows users to enable or disable message notifications from other profiles. If the message notification option is turned on, then at 1602a, the user receives notifications every time a message is received from other users. Further, if the message notification option is turned off, then at 1602b, the user does not receive notifications when a message is received from other users.

The bill notification option 1603 allows users to enable or disable bill notification. If the bill notification option is turned on, then at 1603a, the user receives notifications every time a new bill is generated. Further, if the bill notification option is turned off, then at 1603b, the user does not receive notifications when a new bill is generated.

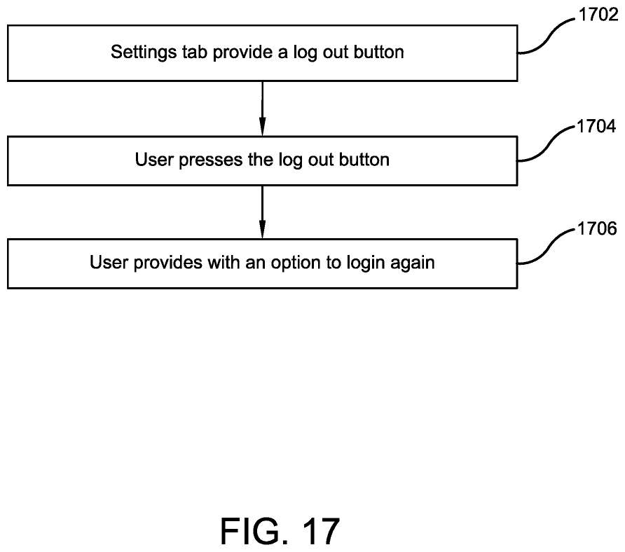

FIG. 17 illustrates a flow diagram showing the operation of a user logging out from the Fitmatch application of the present invention. As shown in FIG. 17, at 1702 the settings tab provides a user with a log out option. Then at 1704, the user presses the log out button for logging out from the software application. At 1706, as the user presses the log out button, the user is logged out and is directed back to the login view for logging in the application again.

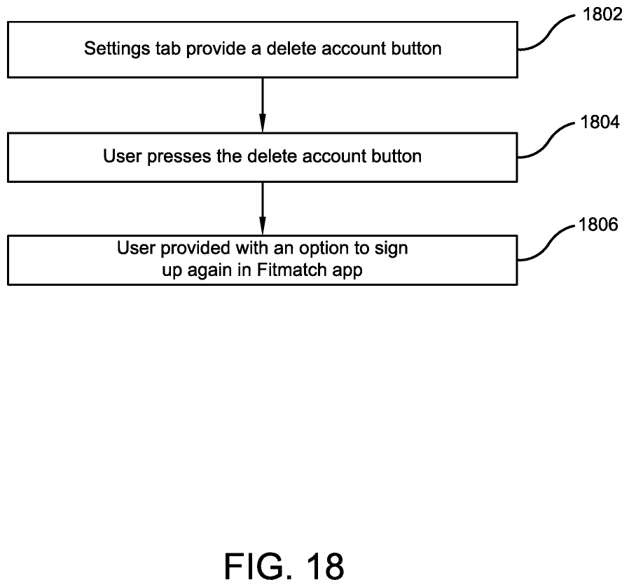

FIG. 18 illustrates a flow diagram showing the operation of a user deleting the Fitmatch application account of the present invention. As shown in FIG. 18, at 1802 the settings tab provides a user with a delete account option. At 1804, when the user presses the delete account button for deleting the Fitmatch application account, the account of the user and all the associated profile data and other personal information is deleted from the server and database of the system. At 1806, as the user deletes the account, the splash screen is displayed, and the user is provided with an option to sign up again in the Fitmatch app.

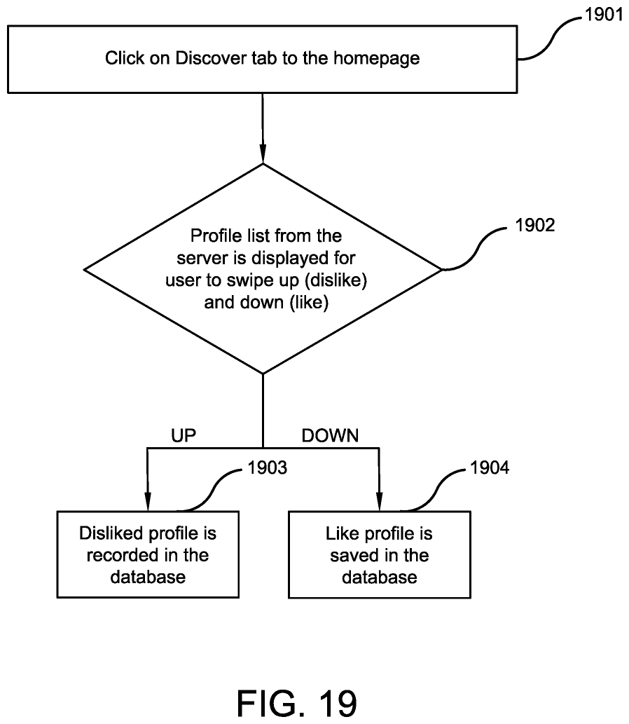

FIG. 19 illustrates a flow diagram showing the exemplary steps performed for liking or disliking a profile when viewed from the list shown on the home page of the Fitmatch application. As shown in FIG. 19, at 1901 a user initially presses or clicks the Discover tab on the homepage of the Fitmatch account. The discover tab provides the user with the potential profile list retrieved from the server based on the preferences, profile and subscription of the user. At 1902, the user can swipe up a profile if the user dislikes the profile and swipe down if the user likes the displayed profile. Based on the swiping up gesture of the user, if it is determined that the user dislikes the displayed profile, then at 1903, the action is recorded in the database of the system of the present invention. Further, at 1902, if it is determined that the user likes the displayed profile based on the swiping down gesture of the user, then at 1904, the liked profile is recorded in the database. Based on the liked and disliked profiles, the server retrieves more profiles for the user and displays them when the user clicks on the Discover tab.

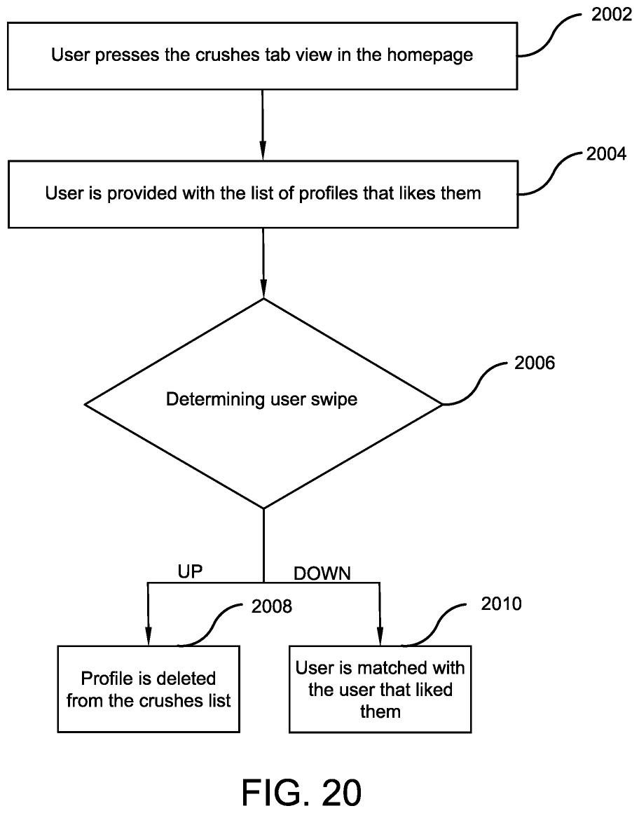

FIG. 20 illustrates a flow diagram showing the actions performed by pressing the crushes tab/button 306 on the homepage of the Fitmatch software application of the present invention. As shown in FIG. 20, initially at 2002, a user presses the crush tab 306 on the homepage of the application. Then at 2004, the user is provided with a list of the potential profiles that have liked the profile of the logged in user. The list can be shown in a grid or stacked manner with the basic details and profile photo displayed on the list. It should be noted that the crushes tab is accessible to a user by paying a subscription fee. Then at 2006, it is determined whether the user has swiped up or down on a particular profile from the list of the displayed profiles in the crushes tab. If it determined that the user has swiped up a profile, then at 2008, the displayed profile is deleted from the crushes list. Further, at 2006, if it is determined that the user has swiped down the profile, then at 2010, the user is matched with the user that likes them. Both the liked profiles and the disliked profiles are recorded in the database coupled to the server of the system.

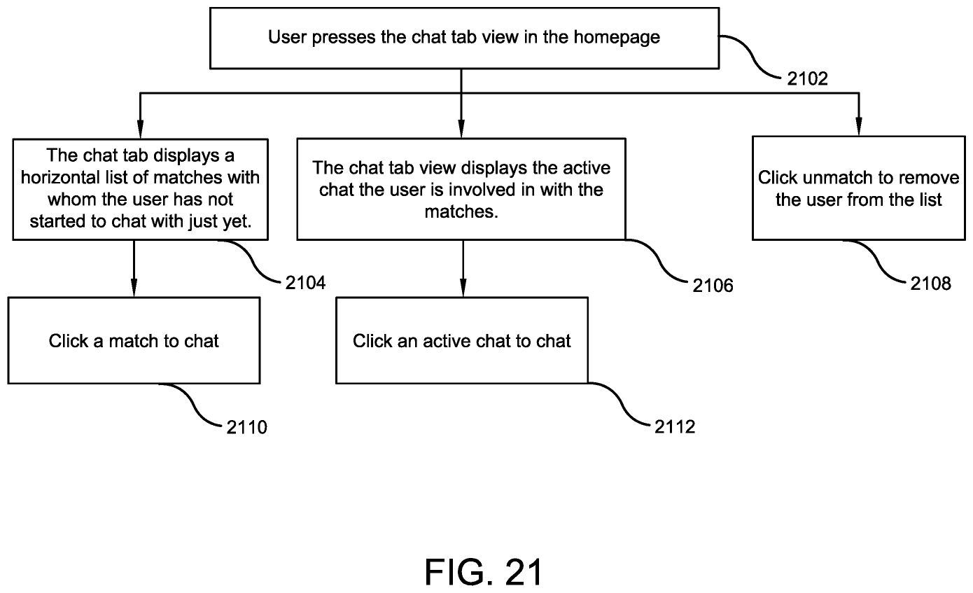

FIG. 21 illustrates the flow diagram showing the options and steps performed when the chat tab 308 on the homepage of the Fitmatch software application is pressed. As shown in FIG. 21, initially at 2102, a user presses the chat tab 308 on the homepage of the Fitmatch application. The chat tab 308 displays different types of lists from which the user can select one or more lists as per the user's needs and/or wants. At 2106, the chat tab displays a sub menu showing the list of active chats in which the user is involved. At 2112, the user can click on one or more contacts to continue the chat. At 2104, the chat tab also displays a horizontal list of matches with whom the user has not yet started to chat. This enables the user to view specific matches with whom the user can initiate chats. At 2110, the user can click one or more matches from the horizontal list to initiate a chat. Further at 2108, the chat tab also displays the respective chat with each user match and a user, by clicking on any contact within the chat view, can unmatch by clicking an option of unmatch offered by the chat tab.

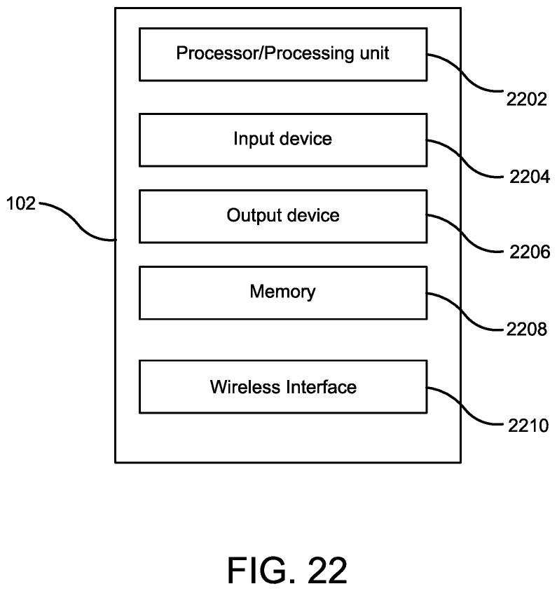

FIG. 22 illustrates an exemplary user device 102 that is used for installing the Fitmatch software application 1000 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the Fitmatch application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer-executable applications configured to be executed by the processing unit 2202. The one or more computer-executable applications may include suitable logic, instructions, and/or codes for executing various operations. The one or more computer executable applications may be stored in the memory 2208. The one or more computer-executable applications includes the fit match application 1000.

The user device 102 comprises an input device(s) 2204, such as a touch input device, a voice input device, etc., for entering data and information. Preferably, the touch interface of the user device 102 is used as the input and various buttons/tabs shown on the Fitmatch application are pressed or clicked by the user. Other input devices such as cameras and microphones are used during video chatting by the user. The display of the user device 102 also acts as the output device 2206 for displaying various contents (i.e., text, images, videos, icons, and/or symbols, etc.) to the user. The display can include a touch screen, and may receive, for example, a touch, gesture, proximity, or hovering input using an electronic pen or a part of a user's body.

The electronic device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM) and other forms of volatile memories known in the art. The processor 2202, in combination with one or more of memory 2208, input device(s) 2204, and output device(s) 2206 is utilized to allow users to execute instructions on the application 1000. The connection to a network is provided by wireless interface 2210.

The wireless interface 2210 enables the user device 102 to communicate with the server 104 and other components of the system 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “system for matching users”, “fitness enthusiast dating system”, and “system” are interchangeable and refer to the fitness enthusiast dating system 100 of the present invention. Similarly, as used herein “Fitmatch application”, “dating application”, and “application” are interchangeable and refer to the Fitmatch application 1000 of the present invention

Notwithstanding the forgoing, the fitness enthusiast dating system 100 and the Fitmatch application 1000 of the present invention can be of any suitable configuration as is known in the art without affecting the overall concept of the invention, provided that it accomplishes the above-stated objectives. One of ordinary skill in the art will appreciate that the configuration and specification of the components of the fitness enthusiast dating system 100 and the Fitmatch application 1000 as shown in FIGS. 1-21 is for illustrative purposes only, and that many other configurations of the fitness enthusiast dating system 100 and the Fitmatch application 1000 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fitness enthusiast dating system configured to facilitate users to seek out other users for a friendship, relationships or as a gym partner in a secure manner comprising:
a Fitmatch software application;
a server system; and
a user device;
wherein the server system is communicatively coupled to the user device via a communications network;
wherein the user device facilitates a user to input a data, receive another's data, and/or transmit the data using the Fitmatch software application; and
further wherein the server system utilizes a two component authentication to verify the data input by the user.

2. The fitness enthusiast dating system of claim 1, wherein the Fitmatch software application is installed on the user device.

3. The fitness enthusiast dating system of claim 1, wherein the user device comprises at least one of a desktop device, a notebook device, a laptop device, a handheld computer, a touch sensitive device, a computing device, a smart-phone, or a smart watch.

4. The fitness enthusiast dating system of claim 1, wherein the server system comprises a software framework, a network of computers, or a combination thereof.

5. The fitness enthusiast dating system of claim 4, wherein the server system comprises an application server and one or more associated databases.

6. The fitness enthusiast dating system of claim 5, wherein the application server and the one or more associated databases are integrated as a single unit.

7. The fitness enthusiast dating system of claim 5, wherein the application server and the one or more associated databased are coupled to each other through a network.

8. The fitness enthusiast dating system of claim 5, wherein the one or more associated databases are configured to store data associated with users registered with the fitness enthusiast dating system.

9. The fitness enthusiast dating system of claim 8, wherein the data comprises at least one of a name, an age, a gender, a fitness preference, a body type, a height, a weight, an ethnicity, a religion, a gym location, or a location away from user.

10. The fitness enthusiast dating system of claim 5, wherein the application server comprises processing circuitry such as a registration engine, a profile update engine, an authentication engine, a user matching engine, a display engine, a notification generator, and an upgrade engine.

11. The fitness enthusiast dating system of claim 10, wherein the registration engine is configured to utilize a facial recognition or a face matching algorithm to match photographs uploaded by a user.

12. The fitness enthusiast dating system of claim 11, wherein the registration engine is configured to utilize a motion verification technique to verify an authenticity of the user.

13. The fitness enthusiast dating system of claim 12, wherein the authentication engine is configured to perform image processing and run facial algorithms to check authenticity of uploaded photographs.

14. The fitness enthusiast dating system of claim 13, wherein the user matching engine enables the user to select a set of criteria to search, wherein the criteria comprises at least one of a body type, a height, an age, an ethnicity, a religion, a gym location, workout preferences, or a distance from the user gym location.

15. A fitness enthusiast dating system configured to facilitate a user to seek out other users for a friendship, relationship, or as a gym partner in a secure manner comprising:
a Fitmatch software application;
a server system comprising an application server and one or more associated databases; and
a user device;
wherein the server system is communicatively coupled to the user device via a communications network; and
wherein the user device facilitates a user to input a first data, receive a second data, and/or transmit the first or second data using the Fitmatch software application;
wherein the server system utilizes a face matching authentication to verify uploaded photos input by the user; and
wherein the server system utilizes motion detection technology to detect motion executed by the user from a camera view to verify the user to prevent fake profiles; and
further wherein the Fitmatch software application comprises an exemplary home page comprising a settings tab, a discover tab, a crushes tab to view profiles that match, a chat tab to initiate a chat, a rewind tab to undo a user's swipe, a flex mode tab, a crushing tab for identifying a strong profile, and a full profile tab to view a full profile.

16. The fitness enthusiast dating system of claim 15, wherein the user swipes down on a profile they like and swipes up on a profile they dislike, and the results are recorded in a database.

17. A method of utilizing a Fitmatch software application and a server to enable secure meetings and dates among registered users comprising the steps of:
installing the Fitmatch software application on a user's device;
activating the Fitmatch software application;
logging into the Fitmatch software application;
receiving profile data and photographs of a user via an application server;
authenticating at the application server uploaded photographs by using facial recognition algorithms and motion detection techniques to ensure the user is real and is not using fake profiles;
if authentication is successful, then enabling the user to upload additional photographs by using the Fitmatch software application;
matching the uploaded photographs with the photographs provided during registration to ensure the photographs uploaded are associated with the same user;
storing the photographs in a database; and
if authentication is unsuccessful, then displaying a failed login notification.

18. The method of claim 17 further comprising a step of providing a user with a potential profile list based on a user's preferences, profile, and subscription.

19. The method of claim 18 further comprising a step of, if the user likes a profile, swiping down the displayed profile; and recording the profile in a database.

20. The method of claim 19 further comprising a step of, if the user dislikes a profile, then swiping up the displayed profile; and recording the action in a database.
